(19) United States
(12) Patent Application Publication
(10) Pub. No.: US 2012/0323569 A1
(43) Pub. Date: Dec. 20, 2012

(54) SPEECH PROCESSING APPARATUS, A SPEECH PROCESSING METHOD, AND A FILTER PRODUCED BY THE METHOD

(75) Inventors: Yamato Ohtani, Tokyo (JP); Masatsune Tamura, Kanagawa-ken (JP); Masahiro Morita, Kanagawa-ken (JP)

(73) Assignee: KABUSHIKI KAISHA TOSHIBA, TOKYO (JP)

(21) Appl. No.: 13/420,824

(22) Filed: Mar. 15, 2012

(30) Foreign Application Priority Data
Jun. 20, 2011 (JP) 2011-136776

(51) Int. Cl. G10L 19/14

(52) U.S. Cl. 704/206; 704/E19.039

(57) ABSTRACT

According to one embodiment, a speech processing apparatus includes a histogram calculation unit, a cumulative frequency calculation unit, and a filter production unit. The histogram calculation unit is configured to calculate a first histogram from a first speech feature extracted from speech data, and to calculate a second histogram from a second speech feature different from the first speech feature. The cumulative frequency calculation unit is configured to calculate a first cumulative frequency by accumulating a frequency of the first histogram, and to calculate a second cumulative frequency by accumulating a frequency of the second histogram. The filter production unit is configured to produce a filter having a characteristic to get the second cumulative frequency near to the first cumulative frequency.

### CROSS-REFERENCE TO RELATED APPLICATION

This application is based upon and claims the benefit of priority from Japanese Patent Application No. 2011-136776, filed on Jun. 20, 2011; the entire contents of which are incorporated herein by reference.

### FIELD

Embodiments described herein relate generally to a speech processing apparatus, a speech processing method, and a filter produced by the method.

### BACKGROUND

As to a synthesized speech waveform, in comparison with a person's natural speech, it sounds indistinctly, which is a problem. In order to solve this problem, by applying a filter to a speech feature before transforming into a speech waveform, speech spectra are enhanced.

In conventional technique to enhance the speech spectra, by using two interpolation functions previously set by a user, correction amount of the filter between LSP coefficient inputted and LSP coefficient having a flat frequency characteristic is determined.

However, in above-mentioned method, a filter characteristic to enhance a speech is adjusted by the interpolation function set by the user. Accordingly, the filter characteristic to enhance the speech spectra cannot be suitably controlled.

### BRIEF DESCRIPTION OF THE DRAWINGS

FIG. 1 is a block diagram of a speech processing apparatus according to a first embodiment.

FIG. 2 is a flow chart of processing of a filter production unit 101 in FIG. 1.

FIG. 3 is a graph showing distribution of a first normalized cumulative frequency according to the first embodiment.

FIG. 4 is a flow chart of processing of a speech synthesis unit 102 in FIG. 1.

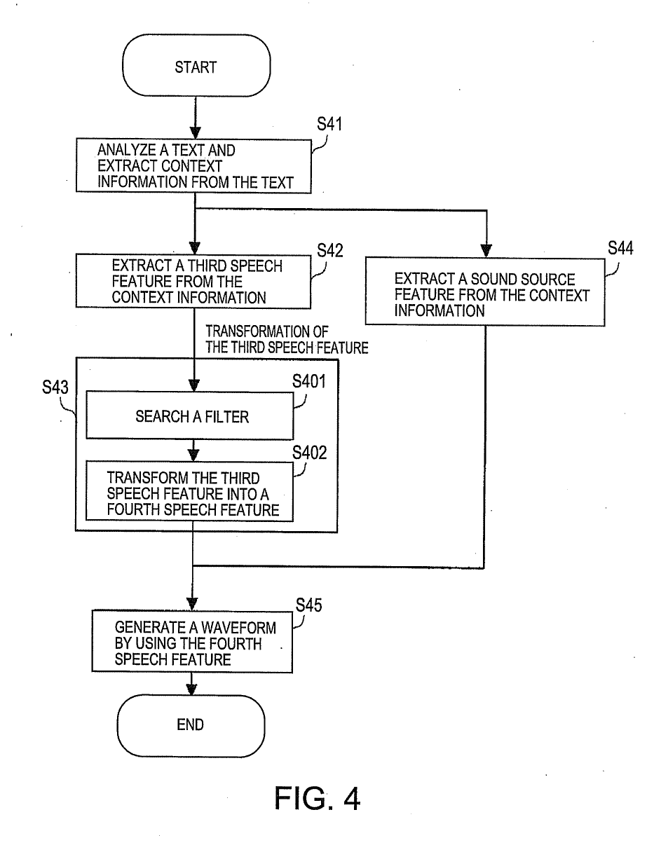

FIG. 5 is two graphs showing distribution of first and second normalized cumulative frequencies according to the first embodiment.

FIG. 6 is a graph showing distributions of normalized cumulative frequency of first, third and fourth speech features according to the first embodiment.

FIG. 7 is a graph showing a spectrum of speech waveform according to the first embodiment.

FIG. 8 is a block diagram of the speech processing apparatus according to modification 1 of the first embodiment.

FIG. 9 is a block diagram of the speech processing apparatus according to modification 3 of the first embodiment.

### DETAILED DESCRIPTION

According to one embodiment, a speech processing apparatus includes a histogram calculation unit, a cumulative frequency calculation unit, and a filter production unit. The histogram calculation unit is configured to calculate a first histogram from a first speech feature extracted from speech waveform, and to calculate a second histogram from a second speech feature different from the first speech feature. The cumulative frequency calculation unit is configured to calculate a first cumulative frequency by accumulating a frequency of the first histogram, and to calculate a second cumulative frequency by accumulating a frequency of the second histogram. The filter production unit is configured to produce a filter having a characteristic to get the second cumulative frequency near to the first cumulative frequency.

Various embodiments will be described hereinafter with reference to the accompanying drawings.

### The First Embodiment

A speech processing apparatus of the first embodiment supposes speech synthesis to generate a speech waveform from arbitrary text. By enhancing speech spectra using a filter, purpose thereof is to get a quality of artificial speech waveform generated by a speech synthesis near to natural speech data of target. In this case, a filter to enhance speech spectra is produced with off-line, and a speech waveform to read arbitrary text is generated by using the filter with off-line.

In off-line processing to produce the filter, a first speech feature sequence is extracted from speech data of target, and a second speech feature sequence is generated by using context information of the natural speech and a speech synthesis dictionary. From the first speech feature and the second speech feature, a first histogram and a second histogram are respectively calculated. Then, a first cumulative frequency is calculated from the first histogram, and a second cumulative frequency is calculated from the second histogram. Based on the first cumulative frequency and the second cumulative frequency, a filter is produced. In this case, in the speech processing apparatus of the first embodiment, the filter is produced by not a user's manual regulation but a basis to get the second cumulative frequency near to the first cumulative frequency calculated from natural speech data of target. As a result, a filter characteristic can be suitably controlled.

In on-line processing to generate an arbitrary speech waveform, a text is analyzed, and a third speech feature for speech synthesis is generated by using the analysis result and a speech synthesis dictionary. Then, the third speech feature is transformed into a fourth speech feature sequence by using the filter generated in off-line processing. Last, a speech waveform of which speech spectra are enhanced is generated from the fourth speech feature sequence.

As to the first embodiment, the third speech feature sequence for speech synthesis is extracted by the same method as the second speech feature sequence generated for producing the filter. Accordingly, by using the filter produced with a basis to get the second cumulative frequency near to the first cumulative frequency, the third speech feature is transformed into the fourth speech feature, and a cumulative frequency of the fourth speech feature can be near to the first cumulative frequency. The cumulative frequency's being near means spectral characteristic's being near of the speech feature. As a result, a quality of artificial speech waveform generated from the fourth speech feature can be near to natural speech data of target.

(Block Component)

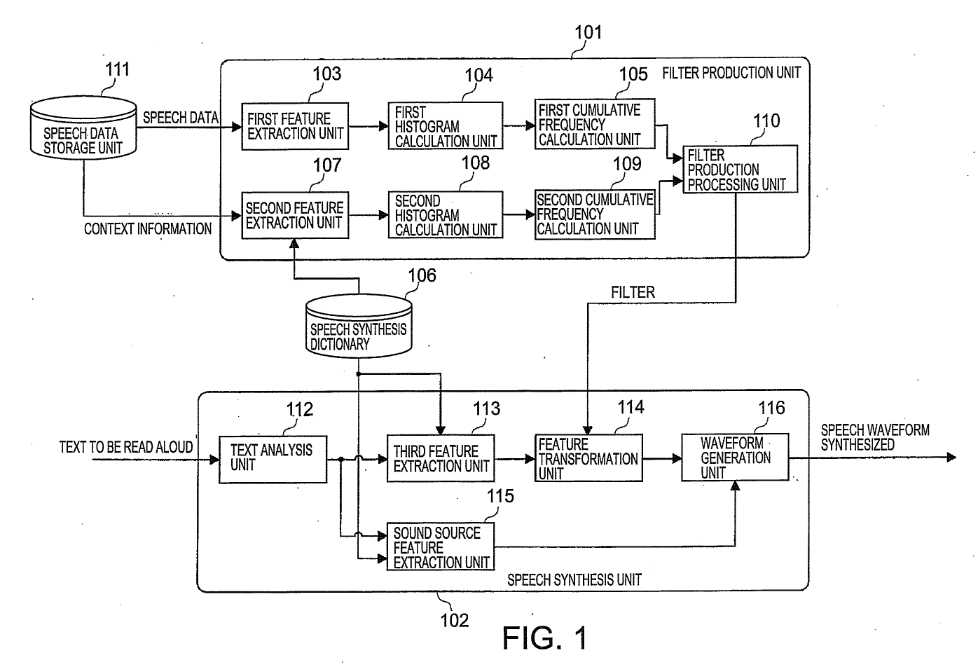

FIG. 1 is a block diagram of a speech processing apparatus according to the first embodiment. In the speech processing apparatus, a speech waveform is generated from arbitrary text by using Hidden Markov Model. This speech processing apparatus includes a filter production unit 101 to produce a filter with off-line, and a speech synthesis unit 102 to synthesize a speech waveform with on-line.

The filter production unit 101 includes a first feature extraction unit 103, a first histogram calculation unit 104, a first cumulative frequency calculation unit 105, a second feature extraction unit 107, a second histogram calculation unit 108, a second cumulative frequency calculation unit 109, and a filter production processing unit 110.

The first feature extraction unit 103 extracts a first speech feature of spectrum from natural speech data stored in a speech data storage unit 111. The first histogram calculation unit 104 calculates a first histogram from the first speech features. The first cumulative frequency calculation unit 105 calculates a first cumulative frequency from the first histogram. The second feature extraction unit 107 generates second speech features of spectra by using context information stored in the speech data storage unit 111 and Hidden Markov Model stored in a speech synthesis dictionary 106. The second histogram calculation unit 108 calculates a second histogram from the second speech features. The second cumulative frequency calculation unit 109 calculates a second cumulative frequency from the second histogram. The filter production processing unit 110 produces a filter to transform the third speech feature into a second speech feature, based on the first and second cumulative frequencies.

The speech data storage unit 111 stores natural speech data as a target to design the filter, and context information of the natural speech data. The context information is phoneme information related to utterance contents of the natural speech data, and linguistic information such as a position, a part of speech or a modification in a sentence. Furthermore, the speech synthesis dictionary 106 stores the Hidden Markov Model used for the second feature extraction unit 107 and the third feature extraction unit 113 to generate the speech feature.

The speech synthesis unit 102 includes a text analysis unit 112, a third feature extraction unit 113, a feature transformation unit 114, a sound source feature extraction unit 115, and a waveform generation unit 116. The text analysis unit 112 analyzes a first text, and extracts context information from the first text. The third feature extraction unit 113 generates a third speech feature of spectrum by using the context information and the Hidden Markov Model stored in the speech synthesis dictionary 106. The feature transformation unit 114 transforms the third speech feature into a fourth speech feature by using the filter produced by the filter production processing unit 110. The sound source feature extraction unit 115 generates a sound source feature by using the context information and the Hidden Markov Model stored in the speech synthesis dictionary 106. The waveform generation unit 116 generates a speech waveform from the fourth speech feature and the sound source feature.

(Flow Chart: the Filter Production Unit)

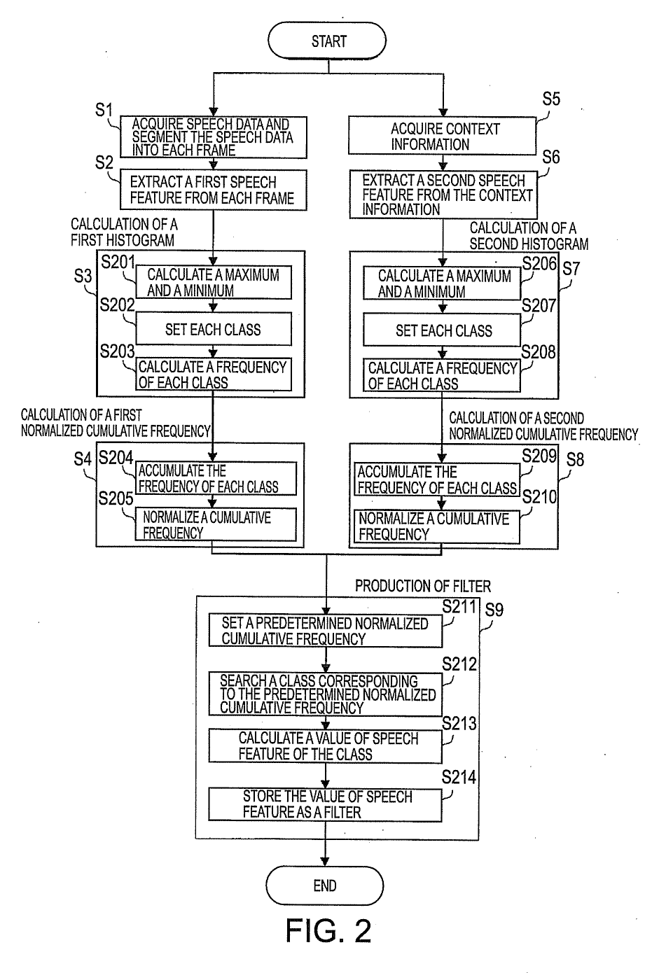

FIG. 2 is a flow chart to produce a filter with off-line in the speech processing apparatus of the first embodiment. First, at S1, the first feature extraction unit 103 acquires natural speech data from the speech data storage unit 111, and segments a speech waveform of the natural speech data into each frame having 20˜30 ms.

Next, at S2, the first feature extraction unit 103 executes acoustic analysis of each frame, and extracts a first speech feature. In this case, the first speech feature is a feature of spectrum representing a voice quality and phoneme information, for example, discrete spectrum, LPC (linear predictive coding), Cepstrum, Mel-Cepstrum, LSP (linear spectral pair), or Mel-LSP acquired by Fourier transform of speech data. In the first embodiment, Mel-LSP is used as the first speech feature. In order to extract the Mel-LSP coefficients, after a spectrum acquired by short-time Fourier transform is transformed into Mel-scale, LSP analysis is subjected to the spectrum.

The number of dimension of the first speech feature is D, and the first speech feature yₙ extracted from n-th frame is represented by an equation (1). In the equation (1), T represents transposition.

yₙ=[yₙ(1), . . . ,yₙ(D)]^{T} (1)

At S3, the first histogram calculation unit 104 calculates a first histogram from the first speech feature of N frames. Detail processing of S3 is explained. First, as to each dimension of the first speech feature, the first histogram calculation unit 104 a maximum yₘₐₓ(d) and a minimum yₘᵢₙ(d) (S201). Then, the first histogram calculation unit 104 sets classes of (I+1) units to a range between the maximum and the minimum (S202), and calculates a frequency of the first speech feature in each class. As a result, a histogram of each dimension represented by an equation (2) is acquired (S203).

h_{y}(i,d)(0≦i≦I) (2)

At S4, the first cumulative frequency calculation unit 105 calculates a first normalized cumulative frequency. Concretely, a cumulative frequency is calculated by accumulating a frequency of each class from the first histogram (S204), and the cumulative frequency is normalized by dividing with the total N thereof (S205). The first normalized cumulative frequency is represented as an equation (3).

$${f}_{y} ( i , d ) = \frac{1}{N} {\sum }_{j = 0}^{l} {h}_{y} ( j , d ) \qquad ( 3 )$$

After normalization of the cumulative frequency, a range thereof is “0˜1”. Next, at S5, the second feature extraction unit 107 acquires context information of speech data stored in the speech data storage unit 111.

At S6, the second feature extraction unit 107 generates a second speech feature of spectrum by using the context information acquired at S5 and the Hidden Markov Model stored in the speech synthesis dictionary 106. In the first embodiment, the second speech feature is Mel-LSP. In the same way as the first speech feature, the number of dimension of the second speech feature is D, and the second speech feature xₘ extracted from m-th frame is represented as an equation (4).

xₘ=[xₘ(1), . . . ,xₘ(D)]^{T} (4)

At S7, a second histogram is calculated from the second speech feature of M frames. Processing of S206˜S208 is same as that of S201˜S203, and explanation thereof is omitted. Moreover, at S206, the maximum and the minimum of the first speech feature may be substituted for those of the second speech feature.

At S8, the second normalized cumulative frequency is calculated as an equation (5).

$${f}_{x} ( i , d ) = \frac{1}{M} {\sum }_{j = 0}^{i} {h}_{x} ( j , d ) \qquad ( 5 )$$

Processing of S209 and S210 is same as that of S204 and S205, and explanation thereof is omitted.

Next, at S9, based on the first and second normalized cumulative frequencies, the filter production processing unit 110 produces a filter to transform a third speech feature (explained afterwards) into a fourth speech feature. Here, the filter is produced on the basis to get the second cumulative frequency near to the first cumulative frequency calculated from natural speech data.

Detail processing of S9 is explained. First, normalized cumulative frequency pₖ(0≦k<K) of K units is set (S211). For example, by assuming that “K=11”, pₖ is set at an interval “0.1” as an equation (6).

p₀=0,p₁=0.1,p₂=0.2, . . . ,p₉=0.9,p₁₀=1.0 (6)

Moreover, pₖ may be set not at processing of S9 but previously.

Next, as to all pₖ(0≦k<K), a class i satisfying an equation (7) is searched in distribution of the first normalized cumulative frequency (S212).

f_{y}(i,d)≦pₖ<f_{y}(i+1,d) (7)

In the same way, as to distribution of the second normalized cumulative frequency, a class j satisfying an equation (8) is searched (S212).

fₓ(j,d)≦pₖ<fₓ(j+1,d) (8)

Next, by linear interpolation of an equation (9), a value y (pₖ,d) corresponding to pₖ is searched in distribution of the first normalized cumulative frequency (S213).

$${y}^{-} ( {p}_{x} , d ) = \frac{\begin{matrix}{p}_{k} ( y ( i ( k ) + 1 , d ) - y ( i ( k ) , d ) ) - \\ {f}_{y} ( i ( k ) , d ) y ( i ( k ) + 1 , d ) + \\ {f}_{y} ( i ( k ) + 1 , d ) y ( i ( k ) , d )\end{matrix}}{{f}_{y} ( i ( k ) + 1 , d ) - {f}_{y} ( i ( k ) , d )} \qquad ( 9 )$$

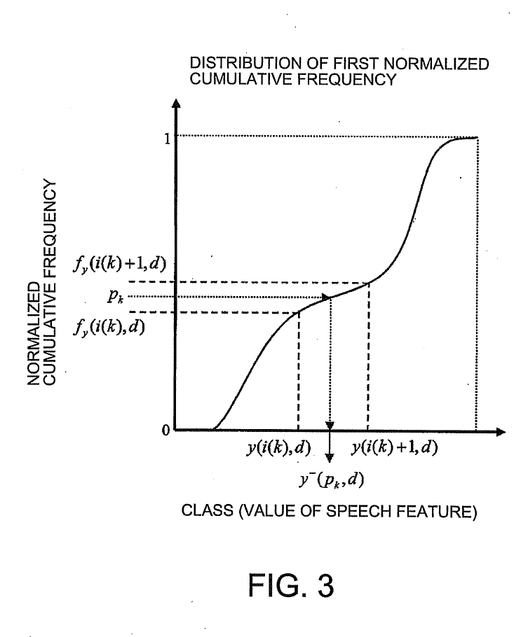

In the equation (9), i(k) is a class searched at S212. Furthermore, in distribution of the first normalized cumulative frequency, y(i(k),d) is a value of speech feature corresponding to the class i(k). FIG. 3 shows a graph representing relationship between pₖ and y (pₖ,d) in distribution of the first normalized cumulative frequency.

In the same way, by linear interpolation of an equation (10), a value x (pₖ,d) corresponding to pₖ is searched in distribution of the second normalized cumulative frequency (S213).

$${x}^{-} ( {p}_{k} , d ) = \frac{\begin{matrix}\begin{matrix}{p}_{k} ( x ( j ( k ) + 1 , d ) - x ( i , d ) ) - \\ {f}_{x} ( j ( k ) , d ) x ( j ( k ) + 1 , d ) +\end{matrix} \\ {f}_{x} ( j ( k ) + 1 , d ) x ( j ( k ) , d )\end{matrix}}{{f}_{x} ( j ( k ) + 1 , d ) - {f}_{x} ( j ( k ) , d )} \qquad ( 10 )$$

At S214, the filter production processing unit 110 stores values of the speech feature calculated at S213 as a filter. A filter T(d) corresponding to d-th dimensional feature is represented as an equation (11).

$$\begin{matrix}T ( d ) = {[ \begin{matrix}{T}_{x} ( d ) \\ {T}_{y} ( d )\end{matrix} ]}^{T} \\ = {[ \begin{matrix}[ \begin{matrix}{x}^{-} ( {p}_{0} , d ) \\ {y}^{-} ( {p}_{0} , d )\end{matrix} ] , [ \begin{matrix}{x}^{-} ( {p}_{1} , d ) \\ {y}^{-} ( {p}_{1} , d )\end{matrix} ] , … , \\ [ \begin{matrix}{x}^{-} ( {p}_{k} , d ) \\ {y}^{-} ( {p}_{k} , d )\end{matrix} ] , … , [ \begin{matrix}{x}^{-} ( {p}_{K} , d ) \\ {y}^{-} ( {p}_{K} , d )\end{matrix} ]\end{matrix} ]}^{T}\end{matrix} \qquad ( 11 )$$

In the equation (11), by using a maximum and a minimum of the first and second speech features, values of the filter T (d) may be replaced with equations (12) and (13).

$$\begin{matrix}[ \begin{matrix}{x}^{-} ( {p}_{0} , d ) \\ {y}^{-} ( {p}_{0} , d )\end{matrix} ] = [ \begin{matrix}{x}_{m i n} ( d ) \\ {y}_{m i n} ( d )\end{matrix} ] & ( 12 ) \\ [ \begin{matrix}{x}^{-} ( {p}_{K} , d ) \\ {y}^{-} ( {p}_{K} , d )\end{matrix} ] = [ \begin{matrix}{x}_{m ax} ( d ) \\ {y}_{m ax} ( d )\end{matrix} ] & ( 13 )\end{matrix}$$

By above-mentioned processing, in the speech processing apparatus of the first embodiment, a filter T(d) is produced for each dimension of the speech feature. The filter T(d) stores a correspondence relationship between the first and second normalized cumulative frequencies by using a predetermined normalized cumulative frequency pₖ. As a result, the feature transformation unit 114 (explained afterwards) can realize transform to get the second normalized cumulative frequency near to the first normalized cumulative frequency by using the filter T(d).

(Flow Chart: the Speech Synthesis Unit)

Next, at S42, the third feature extraction unit 113 generates a third speech feature represented as an equation (14), by using the context information and the Hidden Markov Model stored in the speech synthesis dictionary 106.

xₜ~=[xₜ~(1), . . . ,xₜ~(D)]^{T} (14)

The third speech feature is a feature related to spectrum, which is Mel-LSP in the same way as the first and second speech features. Furthermore, a method for generating the third speech feature is same as the method for generating the second speech feature.

Next, at S43, the feature transformation unit 114 transforms the third speech feature into a fourth speech feature by using the filter T(d) produced with off-line processing.

Detail processing of S43 is explained. First, as to each dimension of the third speech feature, the feature transformation unit 114 searches k(d) satisfying an equation (15) (S401).

x (p_{k(d)},d)≦xₜ~(d)<x (p_{k(d)+1},d) (15)

Next, the feature transformation unit 114 transforms the third speech feature xₜ~(d) of each dimension into a fourth speech feature yₜ~(d) (S402). This transformation is represented as an equation (16).

$$\tilde{{y}_{t}} ( d ) = \frac{{y}^{-} ( {p}_{k ( d ) + 1} , d ) - {y}^{-} ( {p}_{k ( d )} , d )}{{x}^{-} ( {p}_{k ( d ) + 1} , d ) - {x}^{-} ( {p}_{k ( d )} , d )} ( \tilde{{x}_{t}} ( d ) - {x}^{-} ( {p}_{k ( d )} , d ) ) + {y}^{-} ( {p}_{k ( d )} , d ) \qquad ( 16 )$$

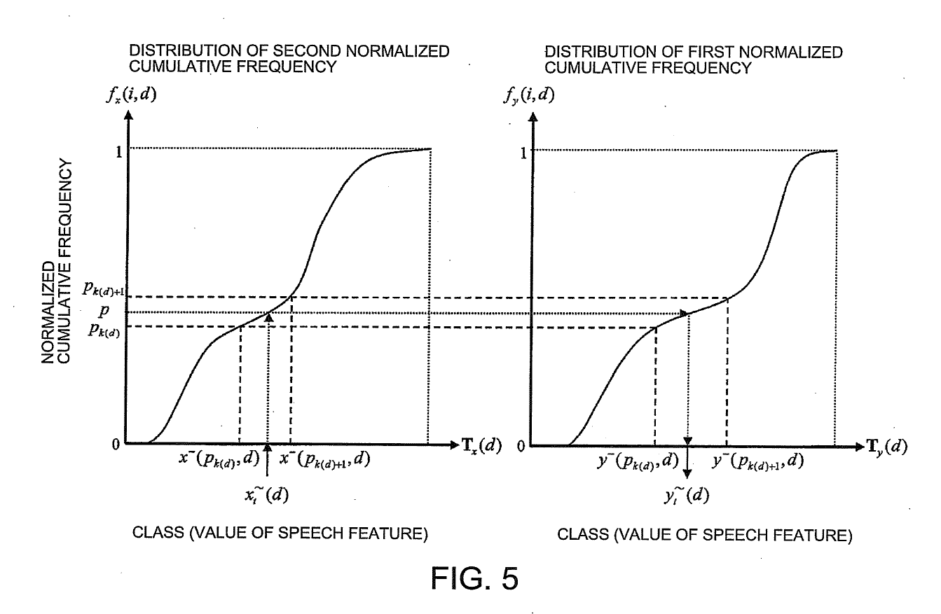

Operation of the equation (16) is explained by referring to FIG. 5. First, in distribution of the second normalized cumulative frequency shown in the left side of FIG. 5, a normalized cumulative frequency p of the third speech feature xₜ~(d) before transformation is calculated by linear interpolation with x (p_{k(d)},d), x (p_{k(d)+1},d), p_{k(d)} and p_{k(d)+1}. Next, in distribution of the first normalized cumulative frequency shown in the right side of FIG. 5, a fourth speech feature y(d) (after transformation) corresponding to the normalized cumulative frequency p is calculated by linear interpolation with yₜ~(p_{k(d)},d), y (p_{k(d)+1},d), p_{k(d)} and p_{k(d)+1}. This processing is represented as the equation (16).

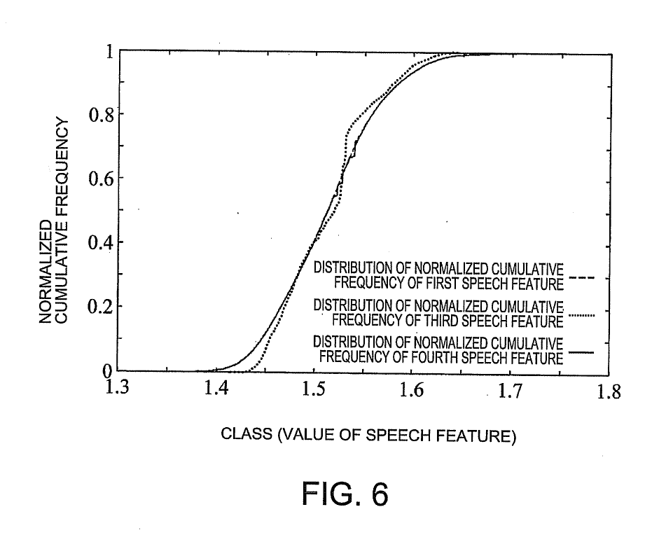

FIG. 6 shows distribution of normalized cumulative frequency of the third speech feature before and after transformation. As shown in FIG. 6, a shape of distribution of the normalized cumulative frequency calculated from the fourth speech feature yₜ~(d) is near to a shape of distribution of the first normalized cumulative frequency calculated from natural speech data. Briefly, this means that spectrum characteristic of the fourth speech feature is near to spectrum characteristic of natural speech data stored in the speech data storage unit 111. The reason is, the third speech feature before transformation is extracted by the same method as the second speech feature, and the filter T(d) is designed on the basis to get the second normalized cumulative frequency near to the first cumulative frequency.

Moreover, if the third speech feature xₜ~(d) generated at S42 is larger than a maximum of the second speech feature or smaller than a minimum of the second speech feature, the third speech feature xₜ~(d) may be outputted without transformation or may be transformed by replacing with the maximum or the minimum.

At S44, the sound source feature extraction unit 115 generates a sound source feature by using the context information and the Hidden Markov Model stored in the speech synthesis dictionary 106. As the sound source feature, non-periodic component and a fundamental frequency are used.

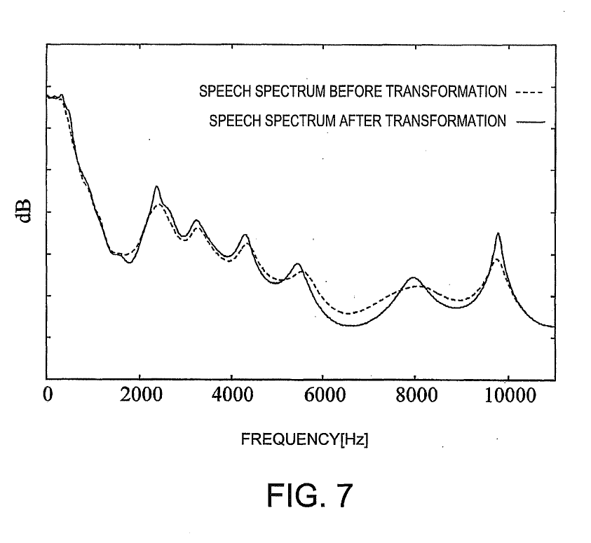

Last, at S45, the waveform generation unit 116 generates a speech waveform from the fourth speech feature yₜ~(d) and the sound source feature. FIG. 7 shows spectrum of speech waveform before and after transformation. As shown in FIG. 7, by transformation with the filter of the first embodiment, speech spectra are enhanced.

(Effect)

As mentioned-above, in the speech processing apparatus of the first embodiment, by using the first cumulative frequency calculated from natural speech data and the second cumulative frequency calculated with the speech synthesis dictionary, a filter is produced on the basis that the second cumulative frequency is near to the first cumulative frequency. As a result, a filter characteristic thereof can be suitably controlled.

Furthermore, in the speech processing apparatus of the first embodiment, the filter characteristic need not be adjusted by the user's manual operation. As a result, time cost necessary for producing the filter can be reduced.

Furthermore, in the speech processing apparatus of the first embodiment, the filter is produced on the basis that the second cumulative frequency (calculated by using the speech synthesis dictionary) is near to the first cumulative frequency (calculated from natural speech data). Then, the third speech feature for speech synthesis is transformed into the fourth speech feature by using this filter. As a result, quality of speech waveform generated from the fourth speech feature can be near to the natural speech data.

### Modification 1

In the first embodiment, two histogram calculation units (the first histogram calculation unit 104 and the second histogram calculation unit 108) are equipped. However, these units may be unified as one unit. In the same way, the first cumulative frequency calculation unit 105 and the second cumulative frequency calculation unit may be unified as one unit.

Furthermore, in the first embodiment, as the first, second and third speech features, Mel-LSP coefficients is used. Besides this, a non-periodic component representing degree of periodicity/non-periodicity included in speech, or a fundamental frequency representing loudness of voice, may be applied. Furthermore, change of feature along time direction, degree of change along frequency direction, difference of the feature between two dimensions, or a logarithmic value, may be applied.

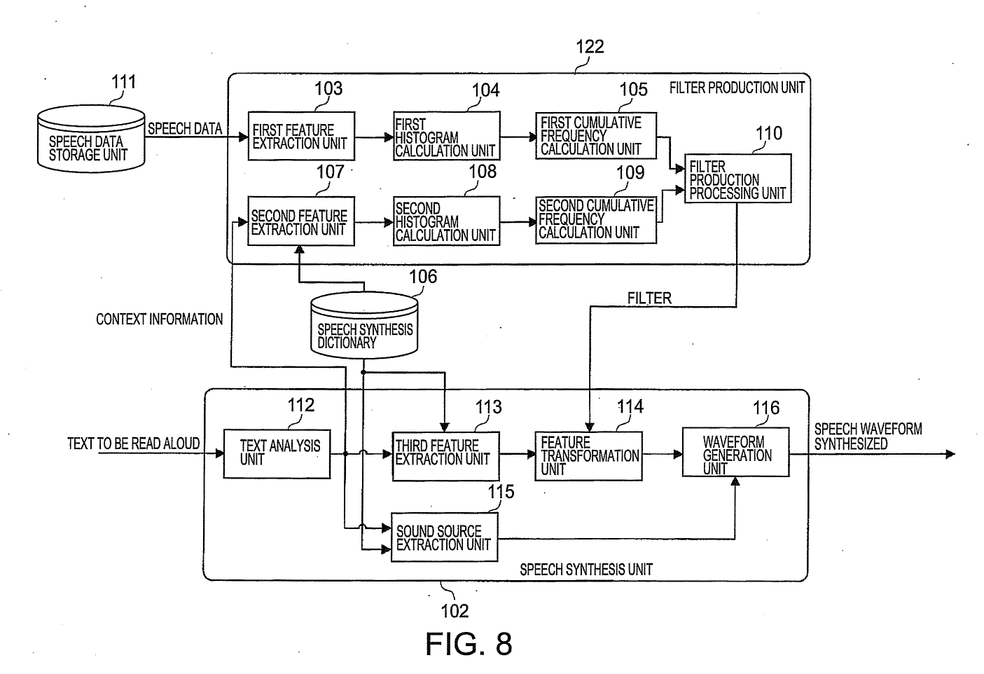

Furthermore, as shown in FIG. 8, the second feature extraction unit 107 may extract the second speech feature by using context information extracted by the text analysis unit 112. In this case, the second speech feature is same as the third speech feature, and the filter production unit 101 produces a filter T (d) for each text to be read aloud. As a result, the filter most suitable for each text can be produced.

Furthermore, in the first embodiment, the cumulative frequency is normalized. However, the filter may be produced without normalization of the cumulative frequency.

Furthermore, the feature transformation unit 114 may apply a filter for not all dimensions but specific dimension. For example, if the total number of dimensions of the speech feature is 50, the speech features of 1st dimension ˜30-th dimension may be transformed by using the filter T(d) without transforming the speech features of 31-th dimension ˜50-th dimension.

### Modification 2

As a filter T(d) of d-th dimension to get distribution of the second normalized cumulative frequency near to distribution of the first normalized cumulative frequency, the filter production processing unit 110 can use coefficients a_{d}̂ and b_{d}̂ satisfying an equation (17).

$${a}_{d}^{\hat{}} , {b}_{d}^{\hat{}} = arg {min}_{{a}_{d} , {b}_{d}} {\sum }_{k = 0}^{K} {\vert {y}^{-} ( {p}_{k} , d ) - \{ {a}_{d} {x}^{-} ( {p}_{k} , d ) + {b}_{d} \} \vert}^{2} \qquad ( 17 )$$

By solving the equation (17), an equation (18) is acquired.

$${a}_{d}^{\hat{}} = \frac{{\sum }_{k = 0}^{K} {y}^{-} ( {p}_{k} , d ) {x}^{-} ( {p}_{k} , d )}{{\sum }_{k = 0}^{K} {{x}^{-} ( {p}_{k} , d )}^{2}} , \\ {b}_{d}^{\hat{}} = \frac{{\sum }_{k = 0}^{K} ( {y}^{-} ( {p}_{k} , d ) - {\hat{a}}_{d} {x}^{-} ( {p}_{k} , d ) )}{K} \qquad ( 18 )$$

The feature transformation unit 114 transforms the third speech feature xₜ~(d) of each dimension into the fourth speech feature yₜ~(d) by using an equation (19).

yₜ~(d)=a_{d}̂xₜ~(d)+b_{d}̂ (19)

### Modification 3

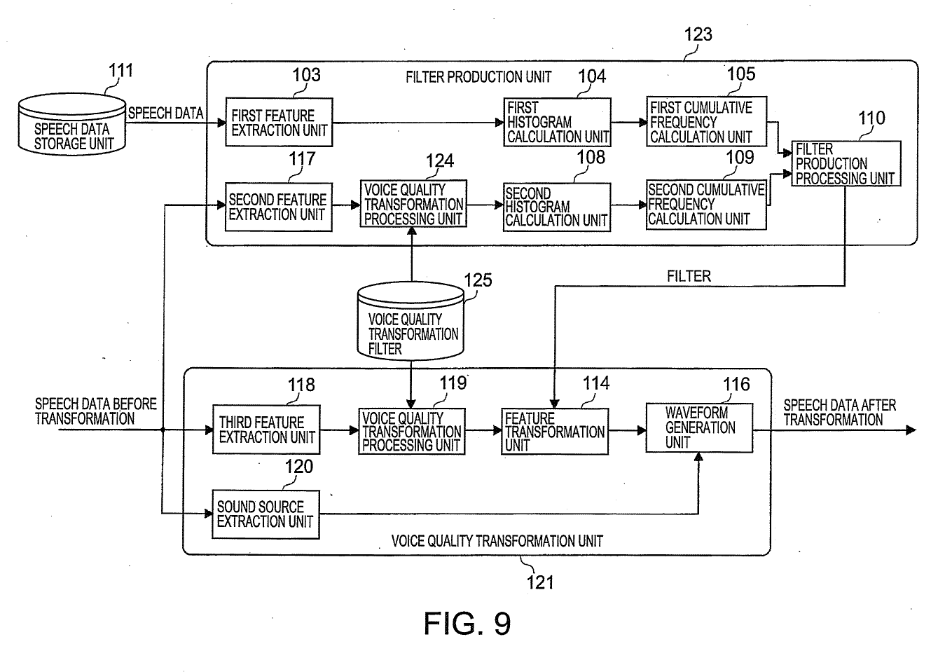

In the first embodiment, speech enhancement for text-to-speech synthesis is explained. However, this speech enhancement can be utilized for another use. FIG. 9 is a block diagram of a speech processing apparatus having a function to transform a voice quality of inputted speech data. The purpose of this speech processing apparatus is to get a voice quality of speech data (before transformation) inputted to a voice quality transformation unit 121 near to a voice quality of natural speech data stored in the speech data storage unit 111. For example, by storing a user's speech data into the speech data storage unit 111, a voice quality of arbitrary speech waveform inputted to the voice quality transformation unit 121 can be transformed so as to be near to the user's voice quality.

This speech processing apparatus includes the voice quality transformation unit 121 to transform a voice quality of speech data. A second feature extraction unit 117 and a third feature extraction unit 118 respectively extract the second speech feature and the third speech feature from speech data. A voice quality transformation processing unit 119 transforms a voice quality of the third speech feature by using a voice quality transformation filter as a filter to transform a voice quality. The feature transformation unit 114 transforms the third speech feature (after transforming the voice quality thereof) into a fourth speech feature having speech spectrum enhanced by the filter T(d).

In modification 3, the second feature extraction unit 117 and the third feature extraction unit 118 mutually extracts by the same method. Furthermore, a voice quality transformation processing unit 124 and the voice quality transformation processing unit 119 mutually transforms a voice quality by the same method. Accordingly, a speech feature inputted to the second histogram calculation unit 108 is same as a speech feature inputted to the feature transformation unit 114. Furthermore, the filter T(d) is generated on the basis to get a cumulative frequency of the second speech feature (having voice quality transformed by the voice quality transformation unit 124) near to a cumulative frequency of the first speech feature (calculated from natural speech data). By transformation using this filter T (d), a voice quality of speech waveform generated from the fourth speech feature can be near to a voice quality of the natural speech data.

In this way, speech enhancement processing of the first embodiment can be applied to not only speech synthesis but also speech feature used for voice quality-transformation or voice encoding.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for processing speech, comprising:
a histogram calculation unit configured to calculate a first histogram from a first speech feature extracted from speech data, and to calculate a second histogram from a second speech feature different from the first speech feature;
a cumulative frequency calculation unit configured to calculate a first cumulative frequency by accumulating a frequency of the first histogram, and to calculate a second cumulative frequency by accumulating a frequency of the second histogram; and
a filter production unit configured to produce a filter having a characteristic to get the second cumulative frequency near to the first cumulative frequency.

2. The apparatus according to claim 1, wherein
the filter production unit sets a predetermined value in a range of the first cumulative frequency and the second cumulative frequency, and produces the filter by using a value of the first speech feature corresponding to the predetermined value of the first cumulative frequency and a value of the second speech feature corresponding to the predetermined value of the second cumulative frequency.

3. The apparatus according to claim 1, further comprising:
a feature transformation unit configured to transform a third speech feature into a fourth speech feature by using the filter;
wherein the third speech feature is extracted by the same method used for extracting the second speech feature.

4. The apparatus according to claim 1, wherein
the first cumulative frequency and the second cumulative frequency are respectively normalized by a total of the first speech feature and a total of the second speech feature.

5. The apparatus according to claim 3, wherein
the second speech feature and the third speech feature are generated by using context information and a dictionary for speech synthesis.

6. The apparatus according to claim 3, wherein
the second speech feature and the third speech feature are transformed by using a filter to transform a voice quality.

7. The apparatus according to claim 3, wherein
the second speech feature is same as the third speech feature.

8. The apparatus according to claim 3, wherein
the first speech feature, the second speech feature and the third speech feature, are any of a spectral envelop, a parameter representing the spectral envelop, a fundamental frequency, or a parameter representing periodicity/non-periodicity of speech.

9. A method for processing speech, comprising:
calculating a first histogram from a first speech feature extracted from speech data;
calculating a second histogram from a second speech feature different from the first speech feature;
calculating a first cumulative frequency by accumulating a frequency of the first histogram;
calculating a second cumulative frequency by accumulating a frequency of the second histogram; and
producing a filter having a characteristic to get the second cumulative frequency near to the first cumulative frequency.

10. A filter produced by the method of claim 9.
